(19) United States
(12) Patent Application Publication
(10) Pub. No.: US 2026/0194414 A1
(43) Pub. Date: Jul. 9, 2026

(54) System and Method for Checking the Sealing Tightness of Packagings

(71) Applicant: Witt GmbH & Co. Holding und Handels-KG, Witten (DE)

(72) Inventor: Martin BENDER, Dortmund (DE)

(73) Assignee: Witt GmbH & Co. Holding und Handels-KG, Witten (DE)

(21) Appl. No.: 19/131,873

(22) PCT Filed: Dec. 1, 2023
(86) PCT No.: PCT/EP2023/083932

§ 371 Date: May 21, 2025

(30) Foreign Application Priority Data
Dec. 2, 2022 (DE) 10 2022 132 050.2

(51) Int. Cl. G01M 3/32

(52) U.S. Cl. CPC G01M 3/3281; G01M 3/3209; G01M 3/3218

(57) ABSTRACT

The disclosure provides systems and methods for checking sealing tightness of packagings filled with protective gas. In one embodiment, a system includes a longitudinal conveyor, an examination chamber located laterally adjacent to the longitudinal conveyor, and a robot. The longitudinal conveyor to convey products contained in packagings filled protective gas. The examination chamber has a protective-gas sensor system and/or a pressure sensor system. Vacuum can be applied to the examination chamber when closed gas-tight by means of a cover associated with the examination chamber. The robot to lay the products contained in the packaging from the longitudinal conveyor onto a bottom surface of the examination chamber and from the bottom surface of the examination chamber back onto the longitudinal conveyor. The system may include additional examination chambers along the longitudinal conveyor to facilitate individually examining a higher quantity of products per unit of time.

### CROSS-REFERENCE TO RELATED APPLICATIONS

This application is a national phase entry of International Patent Application No. PCT/EP2023/083932, filed Dec. 1, 2023, which claims priority to German Patent Application No. DE102022132050.2, filed Dec. 2, 2022, the content of each being incorporated herein by reference in its entirety for all purposes.

### TECHNICAL FIELD

The present disclosure generally relates to a system for checking the sealing tightness of a plurality of packagings filled with protective gas

### BACKGROUND

WO 2013/182 251 A1 discloses a multi-step method for checking the tightness of closed and filled containers as well as a corresponding system for carrying out the method with two sealing tightness checking stations in which the containers are tested twice in succession. To increase the throughput rate, it is proposed to test several packagings simultaneously in one of the sealing tightness checking stations and then intervene to identify the leaking container(s) in the test.

DE 10 2012 216 868 A1 describes a holding device for a tightness check for test specimens by means of a differential pressure test.

EP 3 266 718 A1 describes a packaging machine with a robot having a plurality of suction grippers.

DE 10 2019 108 887 A1 describes a system mentioned at the outset for checking the sealing tightness of packagings filled with protective gas (e.g. food packaging). In this case, CO2 is used as the protective gas. Checking is carried out by subjecting the individual product to be checked to a vacuum in a closed examination chamber. The volume of the examination chamber is then tested for escaping CO2, which is used there as a protective gas, for example. The system described there also provides for the integration of the detection method in a production line, wherein the products are placed individually or simultaneously in a single examination chamber by means of a robot. The examination chamber is then closed and the check is performed. The examination chamber opens again and the checked product(s) are finally exchanged by the robot for the next products to be checked. The robot described there is located at the end of a longitudinal conveyor that moves the products onto another conveyor or into the examination chamber.

Alternatively or additionally to protective gas sensors, pressure sensors can also be used. The examination chamber is then also subjected to a vacuum. If gas escapes from the packaging and it is therefore not sealed tight, no vacuum is detected by the pressure sensor. If, on the other hand, a vacuum is detected, the packaging is sealed tight and the product has passed the test.

The disadvantage of this system is that the products must either be checked individually one after the other in the examination chamber or—in the event that several products are checked simultaneously—only the faulty packaging of at least one of the checked products can be detected. It is not possible to determine which and how many of the products are faulty. This results in problems with regard to the quantity and/or quality when checking the individual products. Checking all products individually is only possible with a considerable amount of time and would slow down production as a whole to an unreasonable extent. For this reason, the aforementioned publication also suggests that products should only be checked on a random basis.

An object of the present disclosure is to develop the known system such that a higher quantity of products per unit of time can be individually examined. Aspects of the present disclosure provide a solution for a system that offers a significantly improved throughput rate, even for individual checking of the samples in the population.

### SUMMARY

To achieve the object, aspects of the present disclosure relate to a system for checking the sealing tightness of a plurality of packagings filled with protective gas, comprising: at least one longitudinal conveyor for conveying products contained in the packagings; at least one robot and at least one examination chamber, which is located laterally adjacent to the longitudinal conveyor, can be closed gas-tight by means of a cover associated with the examination chamber and has a protective-gas sensor system and/or a pressure sensor system and to which vacuum can be applied when the examination chamber is in the closed state; wherein the robot is designed to lay the products contained in the packaging from the longitudinal conveyor into the examination chamber and onto a bottom surface of the examination chamber and from the bottom surface of the examination chamber back onto the longitudinal conveyor. Aspects of the present disclosure also relate to a method for operating a system of this kind. At least two examination chambers are arranged along the longitudinal conveyor.

The arrangement of a plurality of examination chambers makes it possible to check a plurality of products individually in one examination chamber at the same time. Checking several products individually in one examination chamber simultaneously is possible by arranging several examination chambers along the longitudinal conveyor. The examination chambers allow several products to be checked simultaneously, wherein each product is checked individually in one of the examination chambers. The increase in the number of examination chambers and the additional separation of the products during checking in the examination chambers improved the throughput rate, even for individual checking of the samples in the population. The examination chambers are each fitted with a separate cover and can therefore be used independently of each other.

Aspects of the present disclosure also relate to a method for the operation of a system for checking the sealing tightness of a plurality of packagings filled with protective gas, in which
products to be checked that are packaged in a packaging are fed to the system from an input side by means of the longitudinal conveyor,
the products to be checked are placed by the robot(s) from the longitudinal conveyor into the respective open examination chambers,
the respective examination chamber is sealed in a gas-tight manner by means of the cover by moving the cover from the open position to the closed position by means of the cover conveyor device and then subjecting it to a vacuum,
the sealing tightness of the packagings of the products is checked by means of the protective gas sensors,
the cover of the respective examination chamber is then moved from the closed position to the open position by means of the cover conveyor device, and the product is placed on the longitudinal conveyor from the respective examination chamber by means of the robot(s),
and the products are conveyed towards an output side of the system by means of the longitudinal conveyor, wherein checked products that have not passed sealing the tightness check are subsequently discharged.

The sealing tightness can be checked in the respective examination chambers in coordinated cycles so that the highest possible number of products is checked.

In an embodiment, the method according to the present disclosure provides that the examination chamber is pressurised or subjected to atmosphere from below after the sealing tightness has been checked and after the examination chamber has been opened. This prevents protective gas pockets from remaining in the examination chamber volume after the checking process.

A further embodiment of the method according to the present disclosure provides that simultaneously with the transport of a product to be checked from the longitudinal conveyor into the respective examination chamber, a checked product is transported from this examination chamber onto the longitudinal conveyor by means of the respective robot. As the respective robot can grip an unchecked product from the longitudinal conveyor and a checked product from the examination chamber at the same time and exchange them for each other, a high throughput rate can be achieved even if the products are checked individually in the examination chambers. The simultaneous transport of a product to be checked from the longitudinal conveyor to the respective examination chamber and the synchronised transport of a checked product from this examination chamber to the longitudinal conveyor using the same robot ensures an improved throughput rate overall, even when products are checked individually in the system's examination chambers.

In yet a further embodiment, the method according to the present disclosure provides that the sealing tightness of the packagings of the products is checked while the examination chambers are being subjected to a vacuum. This enables an improved throughput rate to be achieved, even for individual product checking in the examination chambers.

### BRIEF DESCRIPTION OF THE DRAWINGS

Aspects of the present disclosure are explained in more detail below with reference to the drawings showing exemplary embodiments. In the drawings:

FIG. 1 schematically shows a three-dimensional (“3D”) view of a system according to an exemplary embodiment of the present disclosure;

FIG. 2 schematically shows a top view of the system according to the embodiment of FIG. 1;

FIG. 3 schematically shows a detailed view of a cover conveyor device of a system according to an exemplary embodiment of the present disclosure;

FIG. 4 schematically shows a detailed view of a cover conveyor device of a system according to another exemplary embodiment of the present disclosure;

FIG. 5 schematically shows a detailed view of a robot of a system according to an embodiment of the present disclosure; and

FIG. 6 schematically shows a further detailed view of the robot of FIG. 5.

### DETAILED DESCRIPTION

An embodiment of the present disclosure provides that at least one examination chamber is arranged along both sides of the longitudinal conveyor. The double-sided arrangement of the examination chambers means that more examination chambers can be provided in total without the system extending particularly far along the longitudinal conveyor.

An embodiment of the present disclosure provides that at least three examination chambers are arranged along both sides of the longitudinal conveyor. This enables a very high throughput rate to be achieved, even for individual product checking in the examination chambers arranged on both sides of the longitudinal conveyor. An embodiment of the present disclosure provides that exactly three examination chambers are arranged along both sides of the longitudinal conveyor. This enables an optimum throughput rate to be achieved, even for individual product testing in the test chambers arranged on both sides of the longitudinal conveyor.

A further embodiment provides that at least two examination chambers, preferably at least four examination chambers, are arranged along both sides of the longitudinal conveyor, and at least two robots are provided. The number of checks per time unit can be further increased by adding more examination chambers and more robots. An embodiment provides that at least six examination chambers are arranged along both sides of the longitudinal conveyor, preferably in total at least twelve examination chambers on the longitudinal conveyor, and at least two robots are provided. This enables a very high throughput rate to be achieved, even for individual product checking in the examination chambers arranged on both sides of the longitudinal conveyor. An embodiment of the present disclosure provides that exactly six examination chambers are arranged along both sides of the longitudinal conveyor and a total of twelve examination chambers on the longitudinal conveyor, and exactly two robots are provided. This enables an optimum throughput rate to be achieved, even for individual product testing in the test chambers arranged on both sides of the longitudinal conveyor.

The robot(s) can be designed as delta robots. Delta robots are particularly well suited to being positioned directly above the longitudinal conveyor. The axles of the spider-like delta robot interact to form a closed kinematic chain. The base of the delta robot is mounted above the moving parts, for example suspended from the ceiling. At least three articulated arms extend from there. The drive technology is special for this type of robot: When the motor drives the axles of the articulated arms, the platform mounted at the bottom moves in the X, Y and Z directions—visually on the sides of a parallelogram. Depending on the number of degrees of freedom, delta robots can also perform rotational movements. This type of robot can be moved by both a linear and a rotary drive. The advantage of this design—compared to articulated robots—is its high accuracy. As the motor is located in the base instead of the joints, the robot arms are extremely light. This generates low inertia and therefore high achievable speeds and accelerations.

The robot(s) can be arranged centrally over the longitudinal conveyor. The central arrangement over the longitudinal conveyor means that the distances to the examination chambers are particularly short. The central arrangement over the longitudinal conveyor makes the examination chambers on both sides of the longitudinal conveyor easily accessible for the robot. Furthermore, no additional installation space is required next to the longitudinal conveyor.

A further development of the present disclosure provides that the robot(s) are each provided with two suction grippers that can rotate about a common axis of rotation and are arranged opposite one another with respect to the axis of rotation. Suction grippers are particularly suitable for pick-and-place processes. The objects to be moved are sucked in using suction cups and transported to their destination. Due to the opposing rotatable arrangement of the suction grippers, the respective robot can grip an unchecked product from the longitudinal conveyor and a checked product from the examination chamber at the same time and exchange them for each other. In this way, the examination chambers act as a kind of buffer store in which the products are temporarily stored. When the buffer store is completely full, continuous buffering takes place according to the first-in-first-out principle, without slowing down the conveying of products along the longitudinal conveyor. The robot(s) are able to replace a product transported on the longitudinal conveyor with a checked product so that there is no overall time delay. The size of the buffer store, which is determined by the number of examination chambers, limits the maximum dwell time of the products in the individual examination chambers. The dwell time must be long enough to carry out the measuring process. The number of examination chambers should therefore be dimensioned in such a way that the throughput, i.e., the number of products transported per time unit by means of the longitudinal conveyor per time unit, is not limited by the sealing tightness check. The examination chambers can be subjected to a vacuum by means of a vacuum pump. The vacuum pump can be switched by means of a solenoid valve and/or a pneumatic angle seat valve, for example. Overall, this results in particularly reliable switching to subject the examination chambers to a vacuum.

A further development provides that each cover of each examination chamber can be moved into a closed position and an open position by means of a cover conveyor device. The cover conveyor device preferably has a hinge via which the cover is hinged to the examination chamber. The cover can be moved back and forth between the open position and the closed position via a preferably pneumatically driven drive cylinder of the cover conveyor device. The cover can be moved between the open position and the closed position at an opening angle of zero to 70 degrees in relation to the bottom surface of the examination chamber. Preferably, the cover is moved to an opening angle of 60 degrees in relation to the bottom surface of the examination chamber in order to reach the open position. The cover conveyor device, which is advantageously pneumatically driven, can fold the cover into this open position in a very short time and move it from there back into the closed position. This enables a high throughput rate to be achieved, even for individual product checking in the examination chambers. A further development provides that the respective cover of the respective examination chamber can be moved into a closed position and an open position by means of a cover conveyor device, wherein the cover conveyor device has a guide holder arranged at an angle of 70°-110°, preferably 80°-100°, relative to the bottom surface of the examination chamber. The cover conveyor device designed in this way means that the system is narrower overall than if the cover were moved laterally parallel to the bottom surface of the examination chamber. Nevertheless, the product can be inserted into the examination chamber from above when the cover is in the open position.

The cover conveyor device preferably has at least two rollers. The rollers allow the cover to be guided quickly and precisely in the guide holder when it is moved back and forth between the open and closed positions. The cover moves along a curved path.

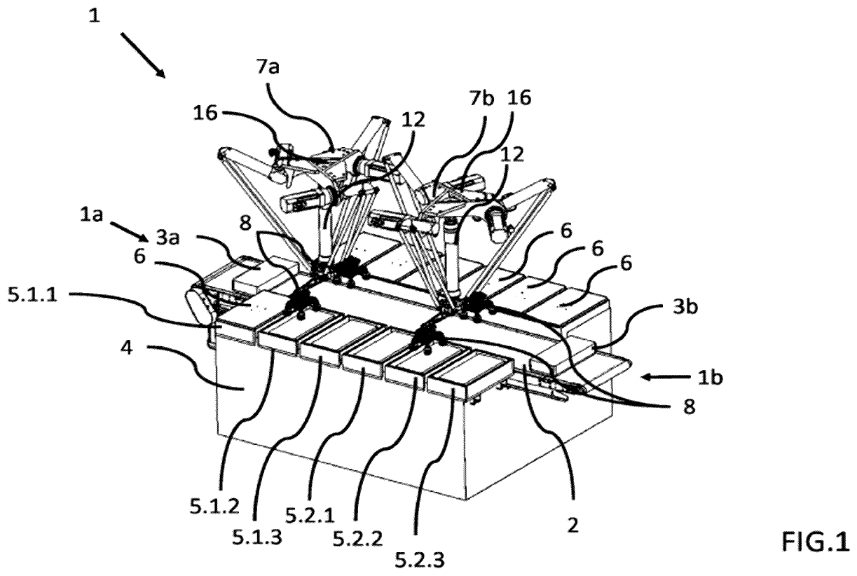

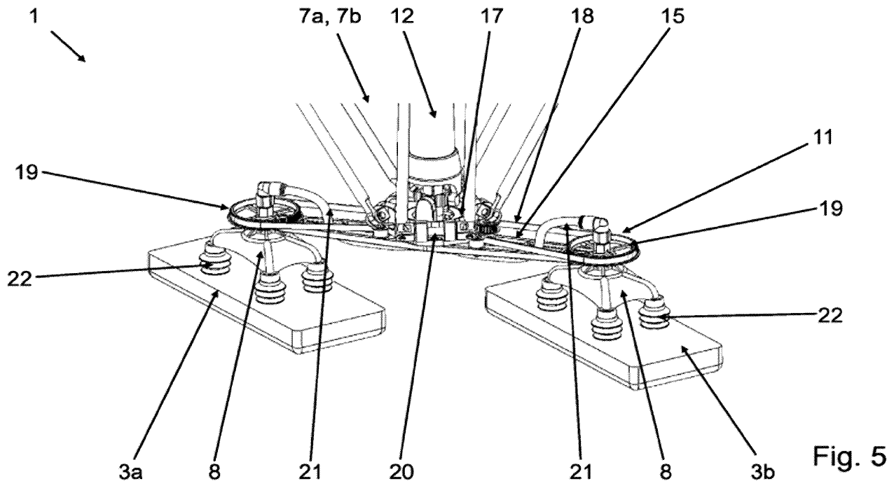

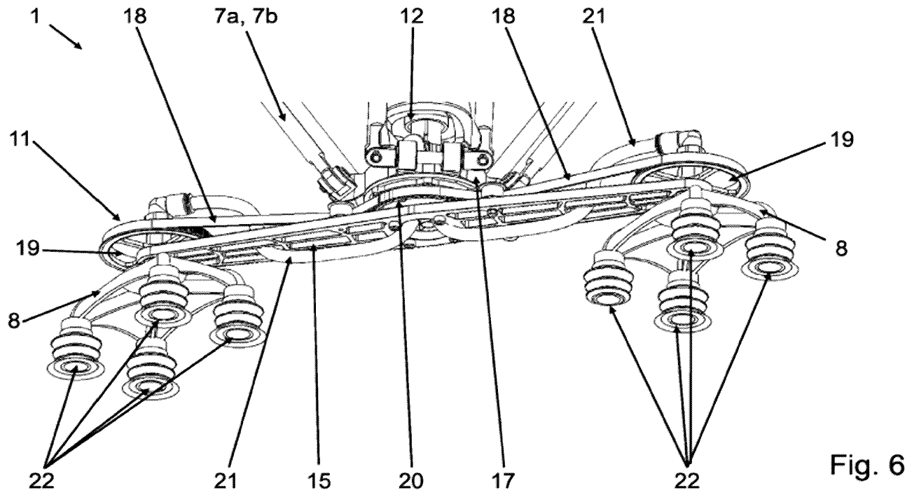

In FIG. 1, a system according to the present disclosure is labelled in its entirety with the reference numeral 1. A longitudinal conveyor 2 is arranged in the centre of system 1. The products 3 are arranged in packagings on the longitudinal conveyor 2 and are conveyed from an input side 1a to an output side 1b of the system 1 by means of the longitudinal conveyor 2. The unchecked products 3a come from the input side 1a and are conveyed out of the system 1 at the output side 1b after the checking process. A housing 4 is arranged around the system 1. A total of twelve examination chambers 5 are positioned in the housing 4, six on each side of the longitudinal conveyor 2. The examination chambers 5 can each be sealed in a gas-tight manner by means of a cover 6. Each examination chamber 1 is also connected to a vacuum pump (not shown here). The vacuum pump can be controlled by means of a first valve (not shown here). The first valve can be designed as a solenoid valve or as a pneumatic angle seat valve. Two robots 7a, 7b, which are designed here as delta robots, are arranged in the centre above the longitudinal conveyor 2. The robots 7a, 7b can be attached to a ceiling (not shown here) or to another type of mount. The robots 7a, 7b each have two suction grippers 8, which are attached to a rotating device 11 (FIGS. 5 and 6). The rotating device 11 (FIGS. 5 and 6) is used to ensure that the products are always aligned in the same way relative to the longitudinal conveyor 2 and to each other. The system 1 is symmetrical overall in relation to the longitudinal axis of the longitudinal conveyor 2.

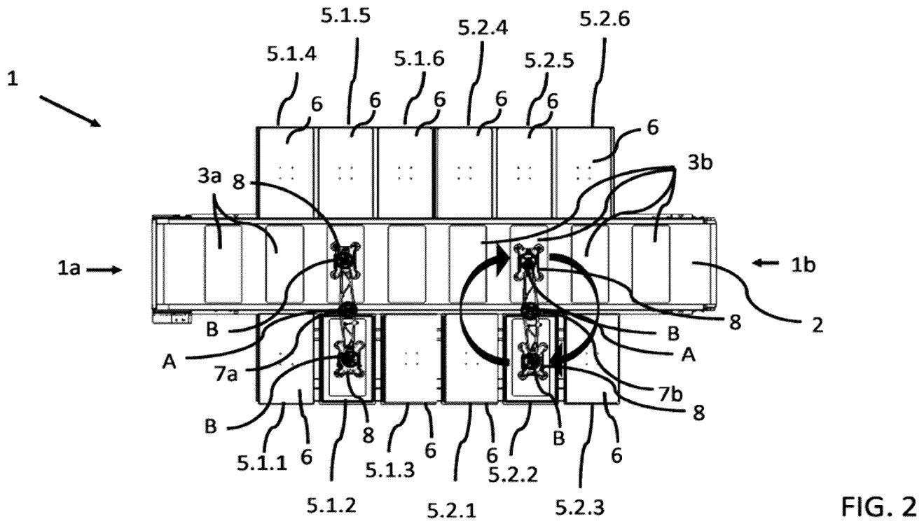

FIG. 2 shows a top view of the system according to the present disclosure shown in FIG. 1 during the checking process. One of the robots 7a, 7b serves each of the six examination chambers 5, i.e. loads them with packagings of the products 3a to be checked and removes the packagings of the checked products 3b from the examination chambers 5. The first robot 7a serves the examination chambers 5.1.1-5.1.6, the second robot 7b serves the examination chambers 5.2.1-5.2.6. With the exception of the examination chambers 5.1.2 and 5.2.2, the remaining examination chambers 5.1.1, 5.1.3-5.1.6, 5.2.1, 5.2.3-5.2.6 are sealed in a gas-tight manner. In these examination chambers 5.1.1, 5.1.3-5.1.6, 5.2.1, 5.2.3-5.2.6, the packaging of a product 3a is checked for sealing tightness.

The packagings of the products 3a to be checked arrive at predetermined intervals from the input side 1a on the longitudinal conveyor 2 in the system 1. The robots 7a, 7b use suction grippers 8 to grip both an unchecked product 3a from the longitudinal conveyor 2 and a checked product 3b from the respective examination chamber 5.1.2, 5.2.2. The corresponding vacuum on the suction grippers 8 is generated with compact ejectors. The tubing 21 for the compressed air supply is guided through the hollow axis 12 (FIG. 1) of the robots 7a, 7b. After lifting the products 3a, 3b, the robots 7a, 7b rotate the suction grippers 8 by 180° about an axis of rotation A—and the servomotors or a rotating device 11 (FIGS. 5 and 6) of the suction grippers 8 rotate the products 3a, 3b relative to the robot rotation about an axis of rotation B—and then place the checked products 3b back onto the longitudinal conveyor 2 and the two unchecked products 3a into the examination chambers 5.1.2, 5.2.2. The rotation about the axis of rotation A (indicated by the directional arrows) takes place with high angular acceleration so that the products 3a, 3b, which are continuously conveyed on the longitudinal conveyor 2, are prevented from accumulating.

The other examination chambers are then approached in sequence by the robots 7a, 7b. Once all examination chambers have been operated, the process starts again from the beginning. The other examination chambers can also be approached by the robots 7a, 7b in a clockwise or anti-clockwise direction. The examination chambers are preferably approached by the robots 7a, 7b alternately and diagonally opposite each other. This means by the first robot 7a in the sequence of examination chambers 5.1.1, 5.1.5, 5.1.3, 5.1.6, 5.1.2 and 5.1.4 and then again from the beginning. For the second robot 7b this is in the sequence of examination chambers 5.2.1, 5.2.5, 5.2.3, 5.2.6, 5.2.2 and 5.2.4 and then again from the beginning. This ensures an improved throughput rate overall, even when checking the products 3a, 3b individually in the examination chambers 5 of the system 1.

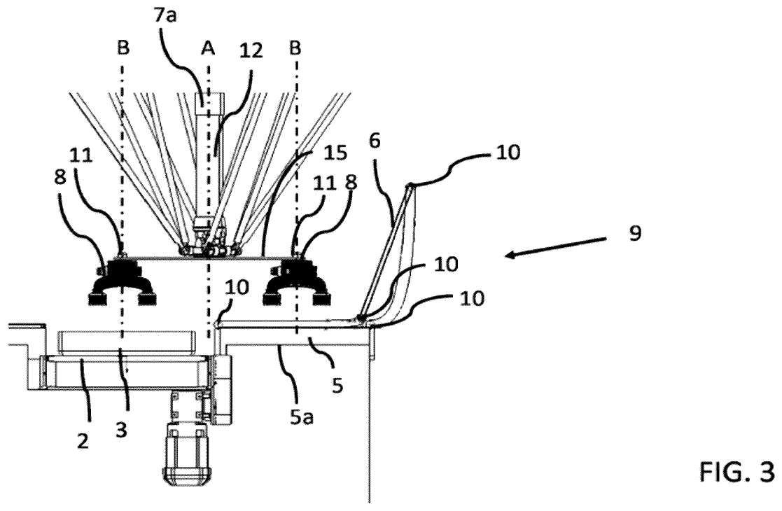

FIG. 3 shows a cover conveyor device 9 for opening and closing the respective examination chamber 5 by means of the respective cover 6. In this exemplary embodiment, the cover 6 of the respective examination chamber 5 is opened and closed via tracks 10 of a guide holder at an angle of approximately 80° to the bottom surface 5a of the examination chamber 5. The cover conveyor device 9 enables the cover 6 to be opened and closed quickly (<0.5 s) in a particularly simple and space-saving manner.

Housing and connecting the components for vacuum generation in the examination chambers 5 and for protective gas measurement, in this exemplary embodiment a CO2 measurement, consisting of a vacuum pump, tubing, a first valve, a second valve, an analysis pump and CO2 sensors (not shown in each case), is provided below the longitudinal conveyor 2.

After the robot 7a, 7b has placed the product 3a to be checked in the examination chamber 5 and is no longer in the collision area with the cover 6, the cover closes in less than 0.5 seconds. Immediately before the examination chamber 5 is closed, the first valve, which is located under the examination chamber 5, switches and the evacuation of the examination chamber 5 by the vacuum pump begins. As soon as the required absolute pressure is reached and the packaging of the product 3a is inflated due to the pressure difference, the protective gas sensor, in this exemplary embodiment a CO2 sensor, begins the CO2 measurement. The measurement result is then transmitted to the system controller and from there, if necessary, to higher-level control instances. Once the measuring process is complete, the cover 6 is opened, the checked product 3b and packaging are removed, conveyed back onto the longitudinal conveyor 2 and finally conveyed to the output side 1b of the system 1 by means of the longitudinal conveyor 2. In addition, the examination chamber 5 is subjected to atmosphere or pressurised via a suitable device (not shown here) in order to flush out residues of the protective gas. This device is controlled via the second valve. The second valve can be designed as a solenoid valve or as a pneumatic angle seat valve.

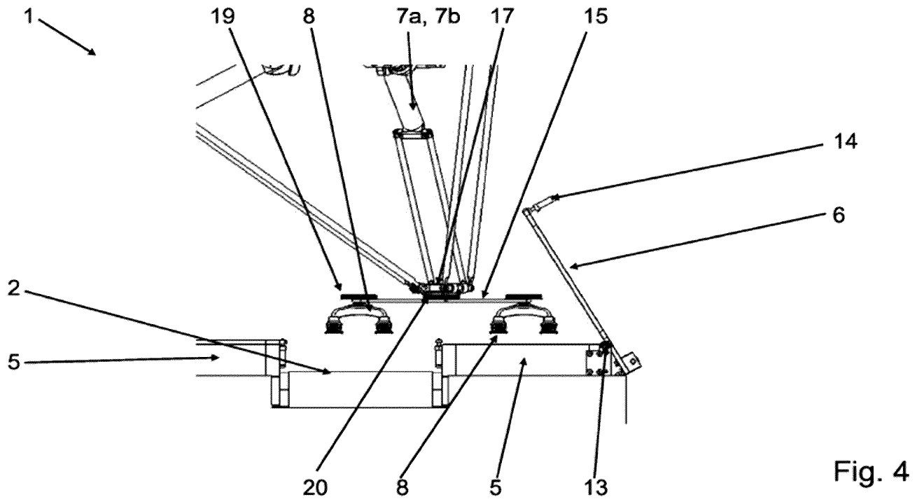

FIG. 4 shows an alternative embodiment of the cover conveyor device 9 for opening and closing the respective examination chamber 5 by means of the respective cover 6. The respective cover 6 of the respective examination chamber 5 can be folded back and forth between a closed position and an open position by means of the cover conveyor device 9. For this purpose, the cover conveyor device 9 preferably has a hinge 13 via which the cover 6 is hinged to the examination chamber 5. A pneumatically driven drive cylinder 14 is provided on each cover conveyor device 9 for rapid movement of the cover 6 between the open position and the closed position. This allows each examination chamber 5 to be opened and closed quickly via a cover 6. The cover 6 should advantageously be moved between the open position and the closed position at an opening angle of zero to 60 degrees in relation to the bottom surface 5a of the examination chamber 5.

FIG. 5 shows a detailed view of a robot 7a, 7b of a system 1 according to the present disclosure. In the embodiment shown here, the robots 7a, 7b, which are preferably designed as delta robots, have a cross-member 15, which can rotate about the axis of rotation A (FIG. 3), for the suction grippers 8, which are arranged opposite the axis of rotation A. The cross-member 15 is rotatably mounted on the movable platform 17, which can be moved parallel to the base 16 (FIG. 1) via the delta robot.

When the cross-member 15 rotates about the axis of rotation A, the suction grippers 8 are each aligned on the cross-member 15 relative to an axis of rotation B (FIG. 3) via a rotating device 11, so that products 3a, 3b lifted by the suction grippers 8 retain their spatial alignment when the cross-member 15 rotates. In this way, the products 3a, 3b placed on the longitudinal conveyor 2 at predetermined distances can be placed in the examination chambers 5 particularly quickly and then returned to the longitudinal conveyor 2 with the appropriate spacing after they have been checked. The rotating device 11 has a belt drive 18, which is placed around the rotating discs 19 of the suction grippers 8, which are mounted on the cross-member 15 so that they can rotate about the axes of rotation B. A sun wheel 20 is provided on the platform 15 of the robot 7a, 7b, which is always orientated in the same way in space and in relation to the fixed base 16; this can be seen more clearly in FIG. 6. The belt drive 18 is located around this fixed sun wheel 20, so that when the cross-member 15 rotates about the axis of rotation A, the rotating discs 19 of the suction grippers 8 are driven by the belt drive 18 in such a way that the suction grippers 8 on the cross-member 15 maintain their orientation in space and in relation to the longitudinal conveyor 2 and the examination chambers 5. In this way, the products 3a, 3b placed next to each other on the longitudinal conveyor 2 can be placed particularly precisely in the examination chambers 5 and, after checking, can be placed back on the longitudinal conveyor 2 in the correct orientation. Using the suction grippers 8, each robot 7a, 7b simultaneously grips a single unchecked product 3a from the longitudinal conveyor 2 and a single checked product 3b from an examination chamber 5. After lifting the products 3a, 3b using the suction grippers 8, the robots 7a, 7b rotate the cross-members 15 by 180° about the axis of rotation A. The products 3a, 3b are rotated about the axis of rotation B relative to the rotation of the cross-member 15 via the rotating device 11 of the suction gripper 8 and thus remain orientated in the same way in space when changing between the longitudinal conveyor 2 and the examination chambers 5. Using the suction grippers 8, each robot 7a, 7b simultaneously places a single checked product 3b on the longitudinal conveyor 2 and a single unchecked product 3a in an examination chamber 5. The belt drive guided via the fixed sun wheel 20 offers a simple way of quickly aligning the products 3a, 3b to the examination chambers 5 and the longitudinal conveyor 2.

FIG. 6 shows that the tubing 21 for supplying compressed air to the suction grippers 8 is guided through the hollow axis 12 (FIG. 1) of the robots 7a, 7b. The tubing 21 is also guided through the fixed sun wheel 20 on the platform 15 of the robots 7a, 7b. The tubing 21 runs along the axis of rotation B into the suction grippers 8. The suction grippers 8 shown in the exemplary embodiment each have four bellows 22 with suction cups, on each of which a negative pressure is built up towards the packagings of the products 3a, 3b. Depending on the design of the product packagings to be checked, a different number of bellows 22 with suction cups other than four can also be used. The size and arrangement of the bellows 22 with suction cups of the suction grippers 8 can also be adapted depending on the design of the product packagings to be checked.

### LIST OF REFERENCE NUMERALS

1 System
1a Input side
1b Output side
2 Longitudinal conveyor
3 Product
3a Unchecked product
3b Checked product
4 Housing
5 Examination chamber
5a Bottom surface
6 Cover
7a, 7b Robot
8 Suction gripper
9 Cover conveyor device
10 Track (guide holder)
11 Rotating device
12 Hollow axis
13 Hinge
14 Drive cylinder
15 Cross-member
16 Base
17 Platform
18 Belt drive
19 Rotating discs
20 Sun wheel
21 Tubing
22 Bellows
A, B Axes of rotation

1. A system for checking sealing tightness of packagings filled with protective gas, comprising:
at least one longitudinal conveyor for conveying products contained in the packagings;
at least one robot;
at least one examination chamber, which is located laterally adjacent to the longitudinal conveyor, can be closed gas-tight by means of a cover associated with the examination chamber and has a protective-gas sensor system and/or a pressure sensor system and to which vacuum can be applied when the examination chamber is in the closed state,
wherein the robot is designed to lay the products contained in the packaging from the longitudinal conveyor into the examination chamber and onto a bottom surface of the examination chamber and from the bottom surface of the examination chamber back onto the longitudinal conveyor, and wherein at least two examination chambers are arranged along the longitudinal conveyor.

2. The system of claim 1, wherein at least one examination chamber is arranged along both sides of the longitudinal conveyor.

3. The system of claim 1, wherein at least two examination chambers, preferably at least four examination chambers, are arranged along both sides of the longitudinal conveyor, and at least two robots are provided.

4. The system of claim 1, wherein the robots are designed as delta robots.

5. The system of claim 1, wherein the robot(s) are arranged centrally over the longitudinal conveyor.

6. The system of claim 1, wherein the robot(s) are each provided with two suction grippers that can rotate about a common axis of rotation and are arranged opposite one another with respect to the axis of rotation.

7. The system of claim 1, wherein the examination chambers can be subjected to a vacuum by means of a vacuum pump.

8. The system of claim 1, wherein the cover of each examination chamber can be moved into a closed position and an open position by means of a cover conveyor device.

9. The system of claim 8, wherein the cover conveyor device has a guide holder arranged at an angle of 70°-110° with respect to the bottom surface of the examination chamber.

10. The system of claim 9, wherein the cover conveyor device has at least two rollers.

11. The system of claim 1, wherein an overpressure supply is arranged on the bottom surface of the individual examination chambers.

12. A method for operating a system according to claim 1, in which
products to be checked that are packaged in a packaging are fed to the system from an input side by means of the longitudinal conveyor,
the products to be checked are conveyed by the robot or robots from the longitudinal conveyor into the respective open examination chambers,
the respective examination chamber is sealed in a gas-tight manner by means of the cover by moving the cover from the open position to the closed position by means of the cover conveyor device and then subjecting it to a vacuum,
the sealing tightness of the packagings of the products is checked by means of the protective gas sensors and/or the pressure sensors,
the cover of the respective examination chamber is then moved from the closed position to the open position by means of the cover conveyor device and the checked products are placed from the respective examination chamber onto the longitudinal conveyor by means of the
and the products are conveyed towards an output side of the system by means of the longitudinal conveyor, wherein checked products that have not passed the sealing tightness check are subsequently discharged.

13. The method of claim 12, wherein the sealing tightness is checked in the respective examination chambers in coordinated cycles so that the highest possible number of products is checked.

14. The method of claim 12, wherein the examination chamber is pressurised or subjected to atmosphere from below after the sealing tightness has been checked and after the examination chamber has been opened.

15. The method of claim 12, wherein simultaneously with the transport of a product to be checked from the longitudinal conveyor into the respective examination chamber, a checked product is transported from this examination chamber onto the longitudinal conveyor by means of the respective robot.

16. The method of claim 12, wherein the sealing tightness of the packagings of the products is checked while the examination chambers are being subjected to a vacuum.
